(19) United States
(12) Patent Application Publication
(10) Pub. No.: US 2019/0368260 A1
(43) Pub. Date: Dec. 5, 2019

(54) Firearm Safe with Emergency Button

(71) Applicant: Shanell Gilbert, Indianapolis, IN (US)

(72) Inventor: Shanell Gilbert, Indianapolis, IN (US)

(21) Appl. No.: 16/426,174

(22) Filed: May 30, 2019

Related U.S. Application Data
(60) Provisional application No. 62/680,381, filed on Jun. 4, 2018.

(51) Int. Cl. E05G 1/10; G08B 25/12; G08B 25/10; E05G 1/04

(52) U.S. Cl. CPC E05G 1/10; E05G 1/04; G08B 25/10; G08B 25/12

(57) ABSTRACT

A firearm safe with an emergency button. The firearm safe with an emergency button has a housing comprising a base, a plurality of sidewalls extending from the base, and an access door, all of which define an interior volume configured to receive at least one firearm therein. A locking mechanism is disposed on the access door for selectively preventing access to the interior volume. A wireless transceiver is configured to communicate wirelessly with a police department or other emergency services departments. An emergency button is disposed on an exterior side of the housing that is operably connected to a control circuit. The control circuit is configured to activate the wireless transceiver. The wireless transceiver is configured to automatically communicate wirelessly with a police department or other emergency services departments when the emergency button is actuated.

### CROSS REFERENCE TO RELATED APPLICATIONS

This application claims the benefit of U.S. Provisional Application No. 62/680,381 filed on Jun. 4, 2018. The above identified patent application is herein incorporated by reference in its entirety to provide continuity of disclosure.

### BACKGROUND OF THE INVENTION

The present invention relates to firearm safes. More particularly, the present invention provides a firearm safe with an emergency button that facilitates automatic wireless communication with a police department or other emergency services department when the emergency button is actuated.

Many individuals own firearms and store them when not in use. Some people store such firearms in easy to find areas, while others store them in unsecured and unlocked places, such as in a drawer or in a shoebox. When a firearm is unsecured, a potentially dangerous situation can arise when the firearm is found and removed. In especially dangerous circumstances, the firearm may fall into the hands of an individual who harbors ill intent. Firearms also present a danger where children or other untrained individuals may gain possession of the firearm and inadvertently discharge a bullet, which may seriously injure or fatally wound another person or themselves.

Devices have been disclosed in the known art that relate to firearm safes. These include devices that have been patented and disclosed in patent application publications. However, the devices in the known art have several drawbacks. Traditional firearm safes provide a secure storage space for firearms and can take the form of a locked case, or a locked compartment in an individual's home, wherein a user may set a lock to selectively prevent access to the stored firearm. However, these traditional firearm safes lack a mechanism wherein an emergency services department is automatically notified in the case of an emergency which requires access to the firearm, or where an unauthorized individual is attempting to access the firearm. Without such a mechanism a child, or an individual with ill intent, may eventually bypass the lock and access the firearm. Where such an event occurs, the safety of innocent individuals may be at risk. Accordingly, a device that provides security for a firearm as well as an emergency button is desired.

The present invention substantially diverges in design elements from the known art and consequently it is clear that there is a need in the art for an improvement to existing firearm safe devices. In this regard the present invention substantially fulfills these needs.

### SUMMARY OF THE INVENTION

In view of the foregoing disadvantages inherent in the known types of firearm safes now present in the prior art, the present invention provides a firearm safe wherein the same can be utilized for providing convenience for the user when storing firearms in a safe and secure manner. The present firearm safe comprises a housing comprising a base, a plurality of sidewalls extending from the base, and an access door, all of which define an interior volume configured to receive at least one firearm therein. A locking mechanism is disposed on the access door for selectively preventing access to the interior volume. A wireless transceiver is configured to communicate wirelessly with a police department or other emergency services departments. An emergency button is disposed on an exterior side of the housing that is operably connected to a control circuit. The control circuit is configured to activate the wireless transceiver. The wireless transceiver is configured to automatically communicate wirelessly with a police department or other emergency services departments when the emergency button is actuated.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the firearm safe.

FIG. 2 shows a perspective view of an embodiment of the firearm safe with a locking mechanism and an emergency button.

FIG. 3 shows a perspective view of an embodiment of the firearm safe in an open configuration.

FIG. 4 shows a block diagram of the representative electronic components of an embodiment of the firearm safe.

FIG. 5 shows a schematic diagram of the function of an embodiment of the firearm safe.

### DETAILED DESCRIPTION OF THE INVENTION

Reference is made herein to the attached drawings. Like reference numerals are used throughout the drawings to depict like or similar elements of the firearm safe. For the purposes of presenting a brief and clear description of the present invention, a preferred embodiment will be discussed as used for the firearm safe. The figures are intended for representative purposes only and should not be considered to be limiting in any respect.

As used herein, “logic” refers to (i) logic implemented as computer instructions and/or data within one or more computer processes and/or logic (ii) logic implemented in electronic circuitry. As used herein, “computer readable medium” excludes any transitory signals, but includes any non-transitory data storage circuitry, e.g., buffers, cache, and queues, within transceivers of transitory signals.

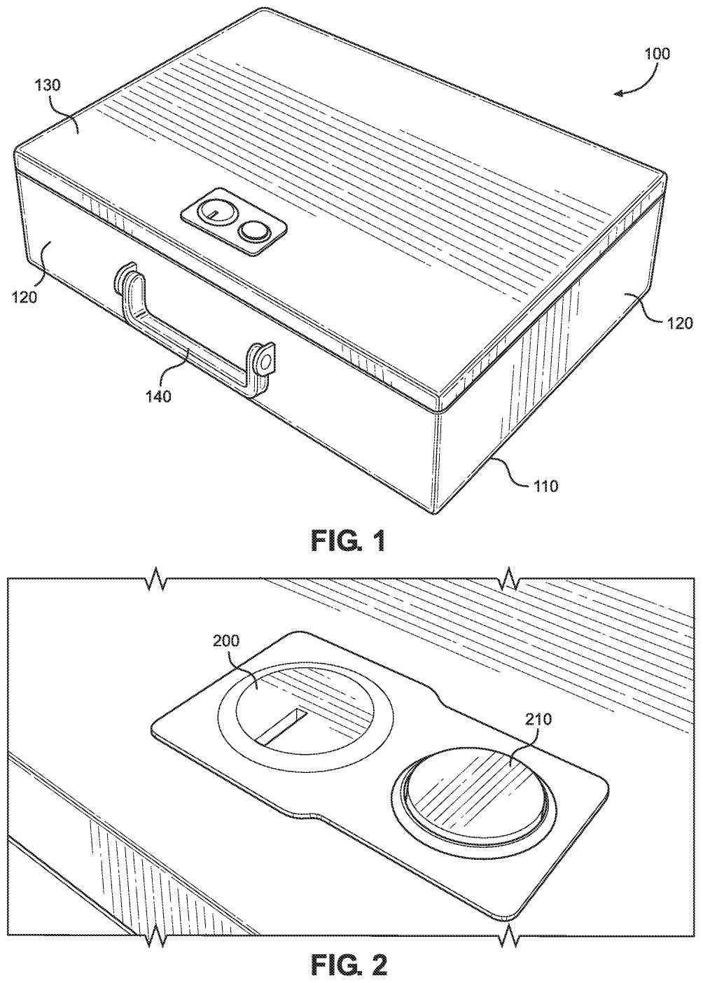

Referring now to FIG. 1, there is shown a perspective view of an embodiment of the firearm safe. The firearm safe has a housing 100 comprising a base 110, a plurality of sidewalls 120 extending from the base, and an access door 130, all of which define an interior volume configured to receive at least one firearm therein. In the shown embodiment, a handle 140 is disposed on one of the plurality of sidewalls 120, enabling an individual to transport the firearm safe. In the shown embodiment, the access door 130 is hingedly secured to the plurality of sidewalls 120, such that the individual is able to access the interior volume of the firearm safe by rotation of the access door 130 via the hinge. In one embodiment, the firearm safe is comprised of steel or any other suitably durable material which provides a sturdy and strong container that is difficult to access by puncturing or prying the material.

Referring now to FIG. 2, there is shown a perspective view of an embodiment of the firearm safe with a locking mechanism and an emergency button. The locking mechanism 200 is disposed on the access door for selectively preventing access to the interior volume. In the shown embodiment, the locking mechanism 200 is a key slot that is configured to receive a unique complementary key. When the complementary key is placed in the key slot, the locking mechanism 200 is configured to rotate and unlock the safe, thereby providing a user with access to the interior volume of the safe. In other embodiments, the locking mechanism 200 comprises any suitable locking and unlocking mechanism, such as a fingerprint scanning lock, a push button combination lock, or a rotary combination lock, for example. In the shown embodiment, both the emergency button 210 and the locking mechanism 200 are disposed on the same mounting plate. Such close proximity to each other allows each component to be quickly accessed for ease of use. In the shown embodiment, the emergency button 210 is a push button that is actuated when a user depresses the button.

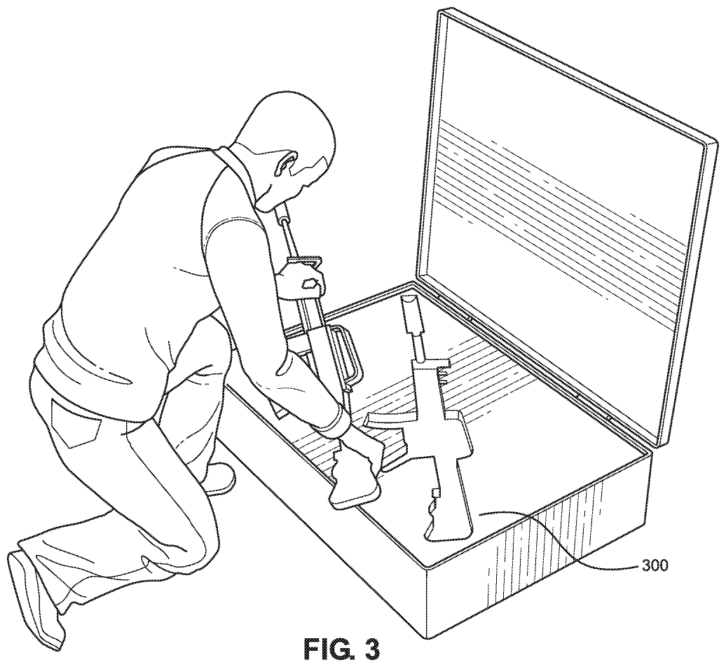

Referring now to FIG. 3, there is shown a perspective view of an embodiment of the firearm safe in an open configuration. In one embodiment, the interior compartment comprises a recessed area 300 that is configured to conform to the shape of an individual firearm, such that the firearm is secured in place in the interior volume. In the shown embodiment, the recessed area 300 is configured to match the size and shape of a firearm. In such an embodiment, the firearm is held in place in a given orientation, thereby providing stability to the firearm when stored, and reducing the possibility that the firearm will move around in the firearm case. In another embodiment, a plurality of walls is configured to define individual compartments in the interior volume. Such individual compartments provide the benefit of allowing a user to store a plurality of firearms, a firearm with ammunition, or various other accessories in an organized manner.

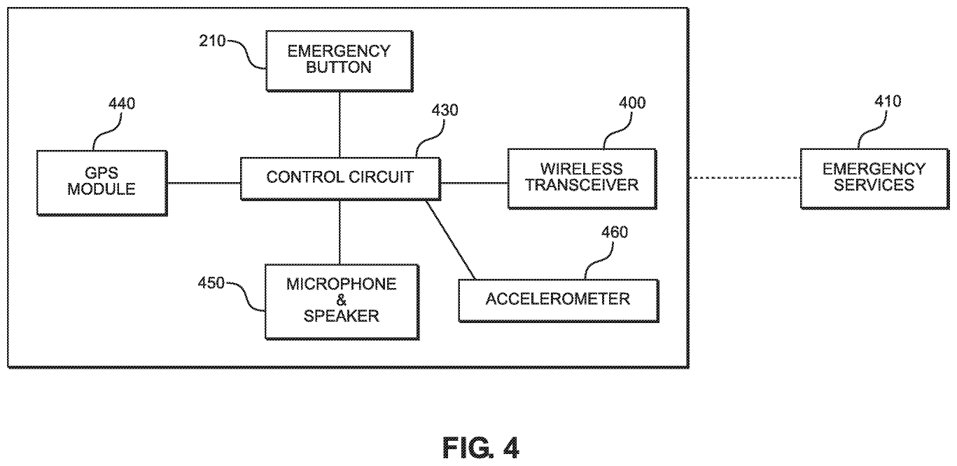

Referring now to FIG. 4, there is shown a block diagram of the representative electronic components of the firearm safe. An emergency button 210 is disposed on an exterior side of the housing and is operably connected to a control circuit 430. The control circuit 430 is configured to activate the wireless transceiver 400 when the emergency button 210 is actuated. The wireless transceiver 400 is configured to automatically communicate wirelessly with a police department or other emergency services departments 410 when the emergency button 210 is actuated. In other embodiments, the wireless transceiver 400 is configured to communicate with an emergency services department 410 via a telephone line, radio signal, and other suitable wired or wireless communications mechanisms.

In a further embodiment, the firearm safe is issued a unique identifier upon manufacture. The unique identifier is transmitted to emergency services departments 410 via the wireless transceiver 400 when the emergency button 210 is actuated. In this manner, the emergency services departments 410 are able to cross-reference the unique identifier and determine to whom the firearm safe is registered. In another embodiment, the control circuit 430 is operably connected to a GPS module 440, such that the control circuit 430 is configured to transmit the GPS coordinates of the firearm safe to the emergency services department 410 when the emergency button 210 is actuated.

In a further embodiment, a speaker and a microphone 450 are operably connected to the control circuit 430. In such an embodiment, the control circuit 430 is configured to activate the microphone and speaker 450 when the emergency button 210 is actuated. In such a manner, a user is able to activate the microphone and speaker 450 at the press of a button and is able to speak directly to a member of the emergency services department 410. In this way, the user is able to convey the nature of an emergency and provide details to the emergency services department 410 of such an emergency.

In another embodiment, an accelerometer 460 is in operable communication with the control circuit 430. The accelerometer 460 is configured to detect a rate of acceleration at which the firearm safe is moving. In such an embodiment, the control circuit 430 is configured to communicate with an emergency services department 410 and transmit the firearm safe's location when the accelerometer 460 detects a rate of acceleration of the firearm safe above a pre-determined threshold value, which indicates that the firearm safe is currently being or has recently been moved from a stationary position.

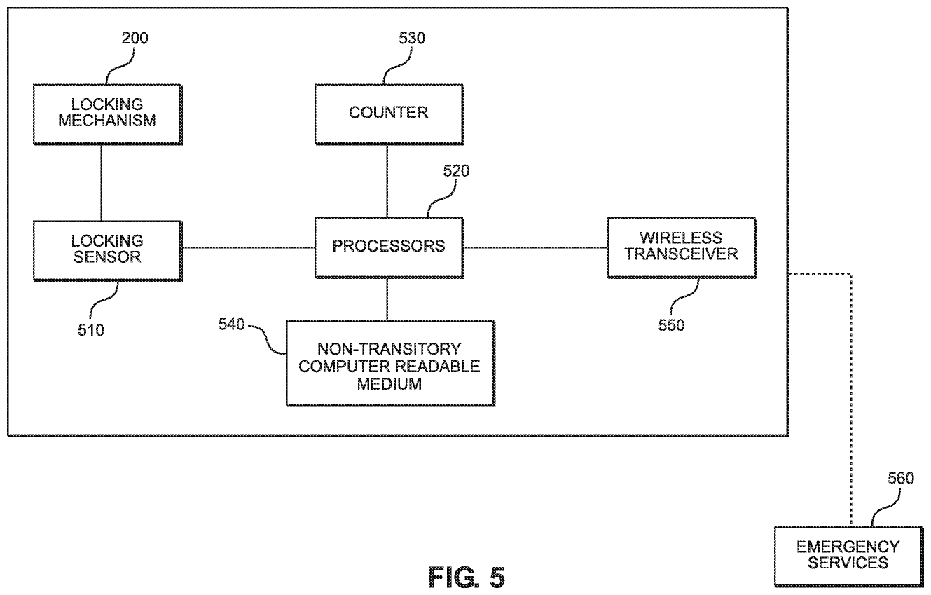

Referring now to FIG. 5, there is shown a schematic diagram of the function of the firearm safe. In the shown embodiment, the locking mechanism 200 further comprises a locking sensor 510 operably connected to one or more processors 520. The locking sensor 510 is configured to detect either a failed entry attempt or a successful entry attempt. A counter 530 is operably connected to the one or more processors 520 and configured to record consecutive failed entry attempts, wherein the counter 530 resets upon the locking sensor 510 detecting a successful entry attempt. The one or more processors 520 are operably connected to a non-transitory computer readable medium 540. A logic is stored in the non-transitory computer readable medium 540 that, when executed by the one or more processors 520, causes the locking sensor 510 to monitor for a specified number of consecutive failed entry attempts. The processor 520 is configured to determine if the number of failed entry attempts exceeds the specified number of consecutive failed entry attempts. The processor is configured to activate the wireless transceiver 550 and automatically contact an emergency services department 560 when the detected number of failed entry attempts exceeds the specified number of consecutive failed entry attempts.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A firearm safe, comprising:
a housing comprising a base, a plurality of sidewalls extending from the base, and an access door, all of which define an interior volume configured to receive at least one firearm therein;
a locking mechanism disposed on the access door for selectively preventing access to the interior volume;
an emergency button disposed on an exterior side of the housing that is operably connected to a control circuit;
the control circuit configured to activate the wireless transceiver;
the wireless transceiver configured to automatically communicate wirelessly with a police department or other emergency services departments when the emergency button is actuated.

2) The firearm safe of claim 1, wherein the firearm safe includes a unique identifier that is accessible by the emergency services department, such that the emergency services department is notified about the unique identifier when the emergency button is actuated.

3) The firearm safe of claim 1, wherein a microphone and speaker are operably connected to the control circuit, such that the control circuit is configured to activate the microphone and speaker when the emergency button is actuated.

4) The firearm safe of claim 1, wherein a GPS module is operably connected to the control circuit, such that the control circuit is configured to transmit the GPS coordinates of the safe to the emergency services department when the emergency button is actuated.

5) The firearm safe of claim 1, wherein the wireless transceiver is configured to communicate to an emergency services department via a radio signal.

6) The firearm safe of claim 1, further comprising a plurality of internal walls configured to define individual compartments in the interior volume.

7) The firearm safe of claim 6, wherein each compartment comprises a recessed area that is configured to conform to the shape of an individual firearm, such that the firearm is secured within an individual compartment of the plurality of compartments.

8) The firearm safe of claim 1, wherein the locking mechanism further comprises:
a locking sensor operably connected to one or more processors;
the locking sensor configured to detect either a failed entry attempt or a successful entry attempt;
a counter operably connected to the one or more processors and configured to record consecutive failed entry attempts, wherein the counter resets upon the locking sensor detecting a successful entry attempt;
the one or more processors operably connected to a non-transitory computer readable medium;
a logic stored in the non-transitory computer readable medium that when executed by the one or more processors causes the locking sensor to monitor for a specified number of consecutive failed entry attempts.

9) The firearm safe of claim 8, wherein the processor is configured to determine if the number of failed entry attempts exceeds the specified number of consecutive failed entry attempts.

10) The firearm safe of claim 9, wherein the processor is configured to activate the wireless transceiver and automatically contact an emergency services department when a detected number of failed entry attempts exceeds the specified number of consecutive failed entry attempts.

11) The firearm safe of claim 1, further comprising an accelerometer configured to detect a rate of acceleration of the firearm safe.
